(19) United States
(12) Patent Application Publication
(10) Pub. No.: US 2026/0350400 A1
(43) Pub. Date: Nov. 5, 2026

(54) System and Method for an LLM with Managed Power Consumption and Communication Protocol Selection for Exploit Detection

(71) Applicant: Booz Allen Hamilton Inc., McLean, VA (US)

(72) Inventors: Benjamin Sparklin, McLean, VA (US); Changfei Shi, McLean, VA (US); Karis Courey, McLean, VA (US); Zane Price, McLean, VA (US); Hieu Nguyen, McLean, VA (US); Emily Kenul, McLean, VA (US); Devin Hill, McLean, VA (US); Nathan David Zameroski, Colorado Springs, CO (US); Daniel Wald, Melbourne, FL (US); Collin Paran, McLean, VA (US)

(73) Assignee: Booz Allen Hamilton Inc., McLean, VA (US)

(21) Appl. No.: 19/255,743

(22) Filed: Jun. 30, 2025

Related U.S. Application Data
(60) Provisional application No. 63/764,439, filed on Feb. 27, 2025.

(51) Int. Cl. G06N 3/0895

(52) U.S. Cl. CPC G06N 3/0895

(57) ABSTRACT

Exemplary embodiments relate a satellite for operation in space using a large language model control with managed power consumption. The satellite includes a processor running an LLM that receives a command and generate binary vectors according to a specified data domain of the LLM and based on the received command. On-board memory dynamically stores the binary vectors for a period of time sufficient for the LLM to use the binary vectors and generate a response to the received command. A communication module selectively communicates with a ground-based node for receiving a file for updating a portion of large language model. The processor updates the large language model with the received file while the large language model is operable. The processor also monitors performances of the LLM and adjusts parameters of the LLM based on a performance threshold.

### CROSS-REFERENCE TO RELATED APPLICATION

This application claims priority to U.S. Provisional Application No. 63/764,439, filed Feb. 27, 2025, the disclosure of which is incorporated in its entirety for all purposes.

### FIELD

The present disclosure relates to use of a large language model with managed power consumption for use in a space-based application.

### BACKGROUND INFORMATION

Known tracking and intercept systems are limited by, for example, reliance on line-of-sight intercept operation, and on terrestrially-based (e.g., Earth-based) continuity of control/command communications for detection, tracking, and/or interception. Such systems often employ radio frequency (RF) control and command which can consume high levels of RF power with complex bidirectional air/ground communication sequences due to the terrestrially-based nature of the command/control operations.

### SUMMARY

An exemplary satellite configured for operation in space using a large language model control in space with managed power consumption is disclosed. The satellite comprising: a processor configured by the large language model to receive a command and generate binary vectors according to a specified data domain of the LLM and based on the received command; on-board memory dynamically storing the binary vectors for a period of time sufficient for the LLM to use the binary vectors and generate a response to the received command; and a communication module configured to selectively communicate with a ground-based node for receiving a file for updating a portion of large language model; the processor being configured to update the large language model with the received file while the large language model is operable; and the processor being configured to monitor performance of the LLM and adjust parameters of the LLM based on a performance threshold.

An exemplary method for using large language model control in space with managed power consumption is disclosed. The method comprising: receiving a command input to the large language model (LLM); generating binary vectors according to a specified data domain of the LLM and based on the received command; dynamically storing the binary vectors in on-board memory for a period of time sufficient for the LLM to use the binary vectors and generate a response to the received command; selectively communicating with a ground-based node for receiving a file to update a portion of large language model; updating the LLM with the received file while the LLM is operable; and monitoring performance of the LLM and adjusting parameters of the LLM based on a performance threshold.

### BRIEF DESCRIPTION OF THE DRAWINGS

Other features and advantages of the present disclosure will become more apparent upon reading the following detailed description in conjunction with the accompanying drawings, wherein like elements are designated by like numerals, and wherein:

FIG. 1 shows an exemplary configuration of a satellite for communicating over the ground-space architecture;

FIG. 2 shows an exemplary system for communicating over a ground-space architecture;

FIG. 3 shows an exemplary architecture of a large language model;

FIG. 4 shows an exemplary intelligent swarm satellite system;

FIG. 5 shows an exemplary subset satellite constellation for an embodiment of the intelligent swarm satellite system;

FIG. 6 shows an exemplary engagement of a space-borne vehicle, such as a missile, by an embodiment of the intelligent swarm satellite system.

FIG. 7 shows an exemplary network topology for an embodiment of the intelligent swarm satellite system; and

FIG. 8 shows an exemplary method for an LLM with managed power consumption.

### DETAILED DESCRIPTION

Exemplary embodiments are directed to an LLM that is configured for deployment in edge devices operating in an extreme environment such as space, subterranean, subaquatic, or any other location where connection to a wide area network is unavailable or limited. The LLM can be installed on a processor or computing system such that during operation the model manages power consumption such that the system consumes energy at a rating of 20 watts or less. To achieve low power consumption, the LLM can include software based radiation hardening, a customized vector store, and a piecewise updating scheme which allows the LLM to remain operable during updates.

Known space-borne vehicle (e.g., drone or missile or other) detection, tracking and/or intercept systems, even where contemplated to include use of satellites and/or space-based weapon systems, are reliant to a significant, if not total, degree on terrestrially-based (e.g., earth-based) detection, tracking, control/command communications, and/or interception. Given the terrestrially-based architecture, such systems often employ RF-based communications with attendant high level power demands on the command and control operation. Such systems also depend in large part of a line-of-sight intercept operation involving a high degree of early detection and accuracy in the tracking/intercept process. There is therefore a need to provide a system which can improve upon known systems to create more robust detection, tracking and intercept operations, preferably with lower power consumption and/or minimal to no reliance on ground-based architecture. The present disclosure is directed to addressing this problem with an entirely space-based tracking and intercept operation following an initial launch detection in the case of earth-based launch of a target space-borne, or air/space-based detection in the case of aerial launch. The proposed solution can autonomously, more efficiently and more quickly detect, track, and intercept a space-borne vehicle, such as a missile or drone which has been launched from ground, air or space. Such operations can be performed with high reliability, robust processing, and without using terrestrially-based tracking, control/command communications, and/or interception to enhance speed, accuracy, power efficiency and reliability of the mission operation. The space-based solution can operate without RF-based communication to reduce power consumption and make space-based form factors an option (e.g., smaller form factor satellites, such as small cube satellites (e.g., “cubesats”) operating with low power and robust peer-to-peer control and command).

Embodiments relate to a space-based missile defense layer including a constellation of proliferated, self-organizing, AI/ML enabled small satellites operating in peer-to-peer networks, providing persistent global ISR and capable of boost phase, ascent and mid-course kinetic kill intercept. This capability can leverage the latest commercially available AI/ML technologies, proven commercial small satellites, high-volume manufacturing capability and the existing and growing in-space commercial and military communications network(s) to deliver a novel, cost-effective system that would complement and integrate into the existing missile warning, tracking and intercept architecture. Using commercial AI/ML tech, proven small satellites, high-volume manufacturing, and current communication networks, enhances and integrates with existing missile warning, tracking, and intercept systems cost-effectively. A large, resilient constellation of over 1,000+ maneuverable hyperspectral small satellites in LEO can autonomously organize and communicate using networks like Starlink, StarShield, and PWSA. These satellites can use autonomous swarming techniques to create synthetic array apertures for ultra high-resolution sensing and high-fidelity targeting during missile launches. They can provide intelligence on enemy capabilities and detect current and future missile threats.

Embodiments for this NextGen missile defense can employ a space-based missile defense layer with a large, dispersed constellation of highly maneuverable nanosats capable of autonomously organizing themselves to support missile defense capabilities. This technology can provide versatile options in enhanced ISR techniques for detection, tracking, and interception of current and future missile threats during boost and midcourse phases, that could not be easily or completely countered. Autonomous swarming techniques could be used by high delta-V nanosats to precisely coordinate their movements to create synthetic array apertures for ultra-high resolution and sensitivity passive sensors, to detect and track ballistic, advanced cruise missile, and hypersonic threats—and to provide intel on enemy capabilities, prior to any conflict. Each of the nanosat squadrons can be part of a peer-to-peer sensor network and would be an IP address on a space-based internet WAN. Each squadron can behave as leader/follower in the formation. Individual members of the squadron can communicate with each other via a secure firewalled LAN connected to the space based mesh WAN (Starlink, StarShield, and PWSA). Although each member of the squadron can have separate roles, in one variation of the technology, the leader can serve as the “eyes” providing the sensor suites to enable precision acquisition, tracking and pointing (ATP) capabilities, while the remaining followers may be dedicated as hit-to-kill interceptors.

Exemplary systems and methods of the present disclosure utilizing large language models (LLMs) in space environments, deep sea or subsurface environments, contested environments, and/or non-internet connected environments are disclosed. Exemplary embodiments can be implemented through retrieval-augmented generation (RAG) and can enable a user to efficiently query and retrieve relevant information from a corpus of instruction manuals and procedural documentation using natural language queries. The disclosed exemplary embodiments leverage state-of-the-art language model techniques while being designed and containerized (e.g., compressed, encrypted, executable file) to run reliably on the resource-constrained computing environments operating at the edge in contested and non-internet connected environments such as outer space. The edge computing system and methods described herein can be configured for resource-constrained deployment, which provides a significant advancement in deploying RAG models in extreme (low power, high radiation) environments, such as outer space, with limited computational resources. The exemplary computing systems and methods can be implemented for a highly specialized domain and use case, such as instruction and operating manuals for a spaceborne vehicle (e.g., International Space System) or vehicle designed for operation in an extreme environment such as a deep sea or deep subsurface environment. In addition, according to exemplary embodiments of the present disclosure, LLMs can be deployed on edge computing devices, embedded systems, connected for communication, and distributed processing in a mesh network absent an Internet connection, traditional data center, or cloud environment.

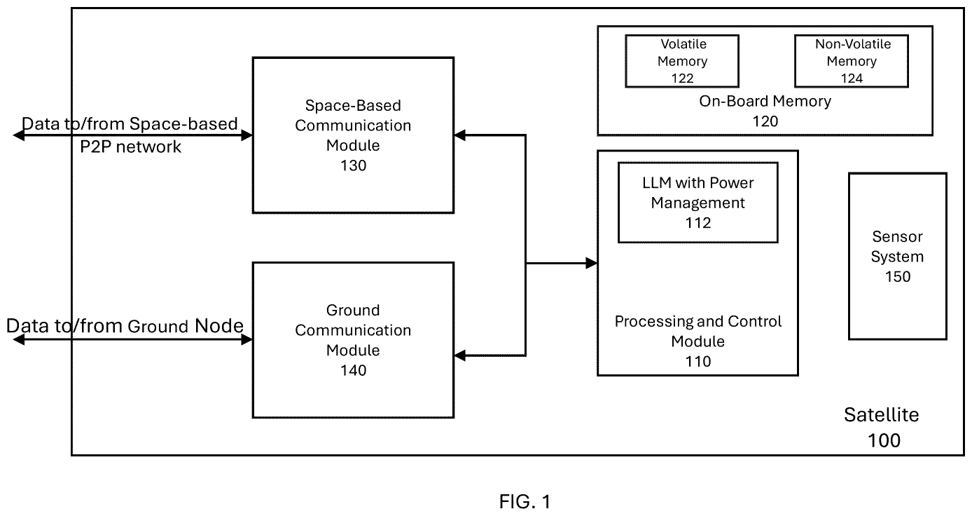

FIG. 1 illustrates an exemplary configuration of a satellite for communicating over the ground-space architecture. The satellite 100 can be configured to operate as an edge computing device in the space-based Internet WAN. As shown in FIG. 1, the satellite 100 can include a processing and control module (i.e., processor) 110, On-Board Memory 120, a space-based communication module 130, and a ground-based communication module 140. The processor 110 can be configured with a large language model configured with power management (LLM) 112 to receive a command and generate binary vectors according to a specified data domain of the LLM 112 and based on the received command. The processor 110 may be implemented in hardware, software, or a combination of hardware and software. According to exemplary embodiments described herein, the processor 110 can be physically hardened against galactic cosmic rays, solar particle events, or any other potentially hazardous emissions in space. The processor 110 may include or have one or more physical and/ operational attributes of a common processor (e.g., a CPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or execute software instructions to perform the operations disclosed herein. The processor 110 can include any integrated circuit or other electronic device (or collection of devices) capable of performing an operation on at least one instruction, which can include a Reduced Instruction Set Core (RISC) processor, a CISC microprocessor, a Microcontroller Unit (MCU), a CISC-based Central Processing Unit (CPU), a Digital Signal Processor (DSP), a Graphics Processing Unit (GPU), a Field Programmable Gate Array (FPGA), etc. The hardware of such devices may be integrated onto a single substrate (e.g., silicon “die”), or distributed among two or more substrates.

The LLM 112 of the processor 110 can be implemented through retrieval-augmented generation (RAG) and can enable a user to efficiently query and retrieve relevant information from a corpus of instruction manuals and procedural documentation using natural language queries.

The on-board memory 120 can be configured to dynamically store the binary vectors for a period of time sufficient for the LLM to use the binary vectors and generate a response to the received command. The on-board memory 120 can be configured to include an inverted index for use by the LLM 112. The inverted index can store a mapping between terms (words or other tokens) and the documents (or other data objects) where those terms appear. For example, the inverted index includes tokens which represents text that is sectioned into words or phrases. The LLM 112 can be configured to tokenize a natural language input by splitting the input text can be split into tokens, such as words, sub-words, or characters. According to an exemplary embodiment, the LLM 112 can split sentences into groups of text, such as chunks. The memory can include a list of documents identifiers (e.g., metadata) for each term stored in the inverted index. The document identifiers are also stored in the inverted index 125. As a result, the inverted index is used for looking up query terms and retrieving a corresponding list of documents. The sentence chunking operation can be used for more efficiently generating the list of document identifiers. For this purpose, the on-board memory 120 includes both volatile and non-volatile memory devices 122, 124. The volatile memory 122 being configured for dynamically storing the binary vectors and the non-volatile memory 124 being configured for storing data for generating a response to the received command. According to an exemplary embodiment, the non-volatile memory 124 can include read-only memory (ROM), Read Only Memory (ROM), Programmable Read only Memory (PROM), Erasable Programmable Read only Memory (EPROM), Electronically Erasable Programmable Read only Memory (EEPROM), and FLASH-EPROM. The volatile memory 122 may include cache memory, random access memory (RAM), or a combination thereof. The volatile memory 122 and/or non-volatile memory 124 can include dynamic or static storage device (e.g., flash memory, magnetic memory, optical memory, etc.) that stores information and/or software instructions for use by the processor. On-Board Memory 120 may include a computer-readable medium and/or storage component. A computer-readable medium (e.g., a non-transitory computer-readable medium) is defined herein as a non-transitory memory device. A non-transitory memory device includes memory space located inside of a single physical storage device or memory space spread across multiple physical storage devices. The non-transitory computer readable medium can include a Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information, and which can be accessed by the processor 110.

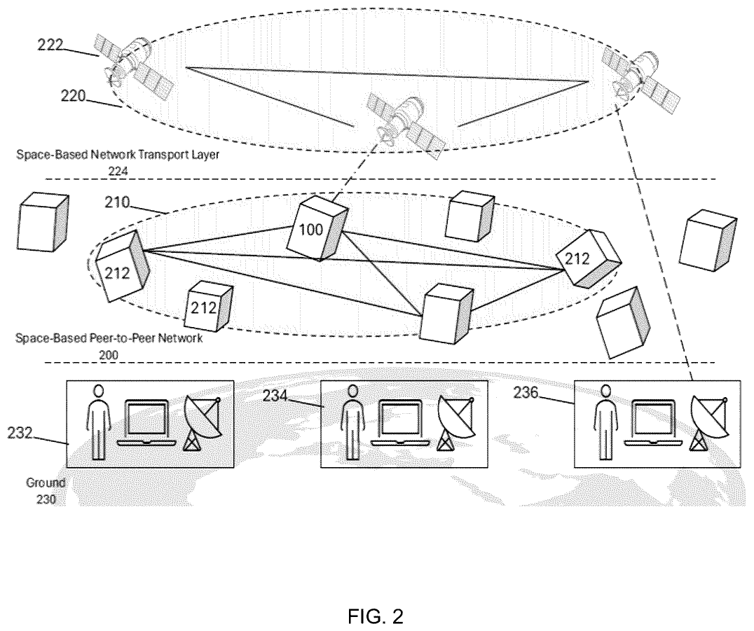

The satellite 100 can include a space-based communication module 130 and a ground communication module 140. The space-based communication module 130 can be configured to establish a communication link with a space-based communication network, such as a space-based mesh network. FIG. 2 illustrates space-based communication and ground communication according to an exemplary embodiment. As shown in FIG. 2, the communication module 130 can allow the satellite 100 to establish an IP address on a space-based Internet Wide Area Network (WAN) 220 and connect to a peer-to-peer sensor network 200. The space-based Internet WAN 220 can include a network of satellites 222 that are arranged and configured to establish a space-based network transport layer 224. According to an exemplary embodiment, the space-based Internet WAN can include known systems such as Starlink, Starshield, Proliferated Warfighter Space Architecture (PWSA), or any other suitable system that provides space-based Internet communication as described herein. The peer-to-peer sensor network 200 can operate as a secure firewalled local area network (LAN) which enables the satellite 100 to join a squadron of satellites 210. The satellite 200 can behave or operate as leader/follower for arranging the squadron 210 in one or more formations and for communicating with the ground 230 for operational data and commands. For example, although each member of the squadron can have separate roles, in one variation of the technology, the leader can serve as the “eyes” providing the sensor suites to enable precision acquisition, tracking and pointing (ATP) capabilities, while the remaining followers may be dedicated as hit-to-kill interceptors.

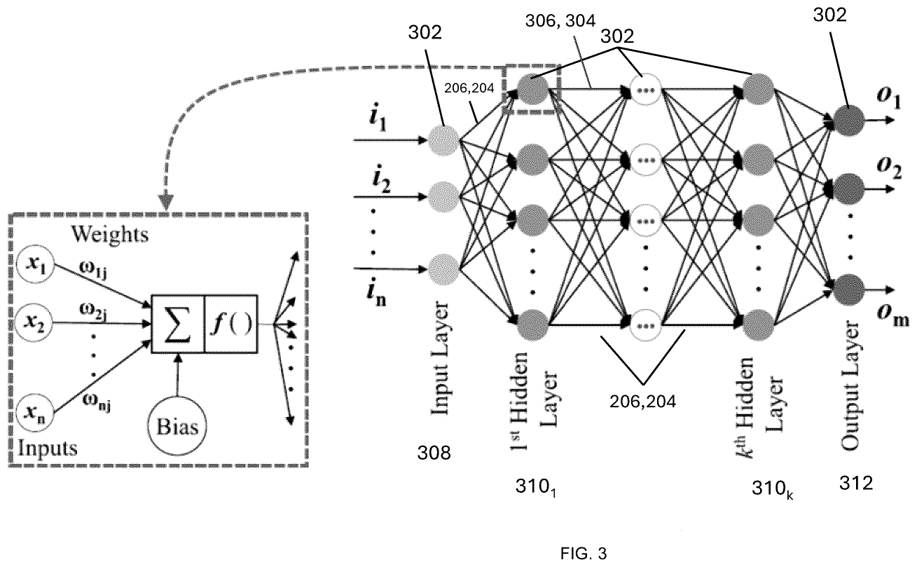

FIG. 3 illustrates an intelligent swarm of plural squadrons according to an exemplary embodiment. As shown in FIG. 3, an intelligent swarm satellite system 300 can include plural satellites 310 configured to orbit the Earth or other celestial body as desired, in one or more orbital paths. While the number of satellites 310 are contemplated to be in the thousands, any number of satellites 310 can be used. The satellites can communicate among each other to form an arrangement for tracking and/or intercepting a space-borne vehicle.

The ground communication module 140 can be configured to selectively communicate with a ground-based node 232, 234, 236 for receiving a file for updating a portion of large language model. The ground communication module can be connected to communicate with the space-based network transport layer 224, which includes at least one satellite 212 that allows for communication to at least one of the ground-based nodes 232, 234, 236 The ground-based nodes 232, 234, 236 can include an operational command center or other location authorized for secure communication with the satellites 200 of one or more squadrons 210.

The processor 110 can be configured to execute instructions to facilitate signal processing, data manipulation, data storage, execution of algorithms, and so forth. For instance, the processor 110 can be in operative association with the memory 120 which includes instructions (e.g., logic, algorithms, models, etc.) stored thereon that when executed by the processor 110 will cause the processor 110 to carry out one or more of the functions disclosed herein. It is contemplated for the processors to receive electrical, optical, and/or electro-optical signals, process those signals, perform computations with the processed signals, and transmits information and/or commands to other satellites 212 and/or other components. Thus, the processor 110 can be equipped with lead lines, waveguides, electrical/optical connectors/couplers, switches/circuity, processing blocks, analog-to-digital converters (ADC), digital-to-analog converters (DAC), filters, processing blocks, transceivers, antennas, and so forth to facilitate receiving/transmitting, processing, and storing signals and data. According to an exemplary embodiment, the processor 110 can receive a command and generate binary vectors according to a specified data domain of the LLM 112 and based on the received command. According to an exemplary embodiment, the command is provided in a natural language format. The command can be a question related to an aspect of a mission, an assignment, or an exercise. The command can also be an instruction that initiates an operation to be performed by the satellite 200. The command can be received from a ground-based node 232, 234, 236 through the ground communication module 140 or received from an edge device such as another satellite 212 or authorized space-borne vehicle or device through the space-based network transport layer 224. The processor 110 converts at least part of the command/request to a vector that represents the semantic meaning of the command/request.

According to an exemplary embodiment, the processor 110 can be configured to include the LLM 112. FIG. 3 illustrates a neural network architecture for an LLM according to an exemplary embodiment of the present disclosure. As shown in FIG. 3, the trained LLM can use one or more deep learning (DL) neural network architectures 300. The neural network(s) 300 can include plural nodes 302 that represent individual computational units. Each node has one or more biased input/output connections that function as transfer or activation functions for combining the inputs and outputs in a specified manner. The neural network can include plural nodes, where each node has one or more inputs 304 and outputs 306 for processing the textual input. The neural network can be formed by an arrangement of the plural nodes 302 into multiple layers, the scheme within which the nodes are connected determines the type and operation of the neural network. For example, the neural network can include an input layer 308, multiple hidden layers 310ₖ, and an output layer 312. Each layer may perform a different or specified transformation on the respective inputs, using a different or specified mathematical calculation or function. Signals travel or are passed between the layers, from the input layer to the output layer via the middle or hidden layers and can traverse any layer and node(s) multiple times. The nodes 302 can be connected in an array and each node can transmit a signal to a node 302 in another layer of the neural network. The input/output (304, 306) connections between the nodes 302 have a corresponding weight wₙⱼ and are combined according to the bias applied at each node. For example, the connections are activation or transfer functions which trigger the respective nodes and combine inputs according to mathematical equations or formulas according to the bias.

According to an exemplary embodiment, the processor 110 can be configured for training machine learning and/or artificial intelligence models (e.g., neural models, neural networks, and/or the like) for processing a natural language query at the edge. For example, the LLM 112 can be trained using the data and/or information provided in the container(s) prior to deployment to the resource-constrained environment (e.g., the edge).

On-Board Memory 120 of the edge computing device 120 can be configured to include an inverted index for use by the LLM 112. The inverted index 125 can store a mapping between terms (words or other tokens) and the documents (or other data objects) where those terms appear. For example, the inverted index can include tokens which represents text that is sectioned into words or phrases. The processor 110 can be configured to create a list of a list of documents identifiers (e.g., metadata) for each term stored in the inverted index. The document identifiers are also stored in the inverted index. As a result, the inverted index is used for looking up query terms and retrieving a corresponding list of documents.

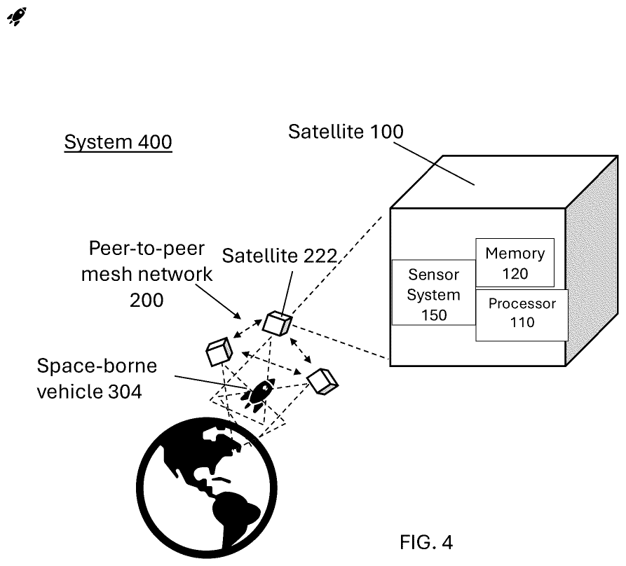

FIG. 4 illustrates an intelligent swarm satellite system according to an exemplary embodiment. The intelligent swarm satellite system 500 can include plural satellites 402 configured to orbit the Earth or other celestial body as desired, in one or more orbital paths. While the number of satellites 402 are contemplated to be in the thousands, any number of satellites 402 can be used. Each of the one or more satellites 402 can include components such as sensors, optics, analyzers, processing modules, and so forth, and can include a communication module for communication using any form of communication protocols including use of RF and/or network (e.g., internet) protocols, or any combination thereof. However, in exemplary embodiments, peer-to-peer communication can be performed exclusively with network based (e.g., IP) based communication, without on-board RF capability where power consumption associated therewith is to be avoided on the satellites.

As shown in FIG. 1, the satellite 100 can include a sensor system 150 that is comprised of one or more of sensors, cameras, optics, RADAR, LIDAR, etc. to detect a space-borne vehicle 304. The sensor system 150 can generate signals to be processed by the processor 110 in accordance with signal processing algorithms (e.g., optical or signal filtering, computer vision, object identification, object classification, etc.). The signals generated by the sensor system 150 can be further processed by one or more processors of one or more satellites 212 (e.g., depending on node responsibility assignment) in the squadron 210 to determine and/or predict a trajectory of the space-borne vehicle 304. For instance, multiple satellites 212 can detect, identify, and classify an object as a space-borne vehicle 304. Confidence levels between the object identifications and classifications of the squadron 210 can be used to determine that the intelligent swarm satellite system 400 has in fact detected a space-borne vehicle 304 threat e.g., if the satellites 212 of a squadron 210 all determine, within a certain confidence level, that the object is identified and classified as the same thing, then the intelligent swarm satellite system 400 can determine that the squadron 210 has detected a space-borne vehicle 304 threat and each are tracking the same space-borne vehicle 304 threat. The squadron 210 can obtain relative position information about the space-borne vehicle 304. This can be done because each satellite's 212 position is known based on a Position, Navigation, and Timing (PNT) navigational system used by each satellite 212. Thus, each satellite 212 can determine position information of the space-borne vehicle 304 relative to itself. The relative position information can be based on Doppler system-e.g., the satellites 212 can generate radio signals and determine position and movement of the space-borne vehicle 304 using Doppler techniques. Each satellite of the squadron 210 that has detected the space-borne vehicle 304 can track the space-borne vehicle 304 by continually generating relative position information. The relative position information from the squadron 210 that have detected and are tracking the same object (e.g., each are tracking the same space-borne vehicle 304) can be analyzed, fused, etc. to determine a motion vector(s) for the space-borne vehicle 304. Algorithms can then be used to predict the missile's 104 trajectory based on the motion vector(s).

Some embodiments can include plume image analysis as part of the object identification and classification. For instance, one or more of the machine learning algorithms can be trained on a trained data set of missile and/or rocket image plumes. The sensory system 150 of the satellite 100 can capture images of a plume of a missile or rocket and feed it to the machine learning algorithm(s) to determine which type of missile or rocket it is (e.g., whether it is a weapon or other type of missile or rocket). The satellite 100 can, for example, capture downward-looking images of a space-borne vehicle signature to then compare against stored profiles in a look-up-table (LUT) for classifying the space-borne vehicle 304 and assessing its characteristics form a space-borne vehicle database (e.g., range, speed, maneuverability and so forth).

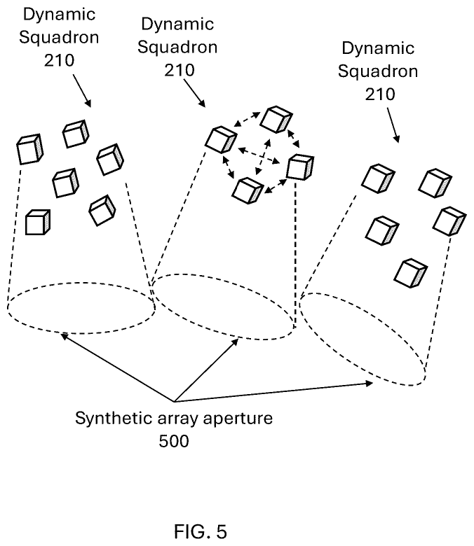

FIG. 5 illustrates an intelligent swarm satellite system can be configured for space-borne vehicle 304 tracking and intercept. As shown in FIG. 5, the intelligent swarm satellite system can be placed in orbit about the Earth. This can include low earth orbit (LEO). Should space-borne vehicle 304 (e.g., drone, missile, etc.) be sent into LEO, or with a trajectory that is predicted to enter LEO, then the intelligent swarm satellite system 100 can detect the space-borne vehicle 304. The intelligent swarm satellite system 400 can identify the space-borne vehicle 304 via classification techniques as a threat (e.g., the space-borne vehicle 304 is a weapon), and take action to intercept the space-borne vehicle 304. The intelligent swarm satellite system can include plural satellites 212 that not only work as a swarm to form a synthetic array aperture(s) 500 for detection/tracking of the space-borne vehicle(s) 304, but they can also work as a swarm to intercept the space-borne vehicle(s) 304.

The intelligent swarm satellite system can include plural satellites 212 forming a constellation configured for peer-to-peer satellite communication. For instance, the intelligent swarm satellite system can include a communication protocol forming a distributed application architecture that can partition tasks between satellites 212. Each satellite 212 can be an edge node in the architecture and shares computational/processing resources such that each satellite 212 can both use and provide computational/processing resources. The peer-to-peer network can be an unstructured topology, a structured topology, a hybrid topology, or any combination thereof and so forth. Node responsibility (e.g., which/how/when satellite 212 performs a task, which/how/when satellite 212 is using computational/processing resources, which/how/when satellite 212 is providing computational/processing resources, etc.) can be determined based on topology and routing algorithms. For instance, a machine learning algorithm can determine optimal node responsibility assignments based on sensed conditions. Node responsibility assignments can be modified based on a change in conditions. For example, a machine learning algorithm may have a certain node responsibility assignment when searching for space-borne vehicles 304, but then adjusts node responsibility assignments when a space-borne vehicle 304 is detected, or when multiple space-borne vehicles 304 are detected, or when one or more space-borne vehicles 304 are being engaged, or when there is an obstruction in the synthetic array aperture 400, or when a satellite 212 is malfunctioning, inoperable, or otherwise unavailable, etc. With a peer-to-peer communication network between the plural satellites 212, a distributed communication network can be generated in which satellites 212 can communicate with each other and share each other's resources. A distributed communication network is one aspect that can facilitate the squadron 210 behaving as a swarm.

While it is contemplated for the plural satellites 212 to form a constellation (e.g., a grouping, a mosaic, etc.), it is not necessary for them to do so. Rather, the plural satellites 212 are arranged to: 1) communicate with each other via a peer-to-peer network topology; and 2) are able to scan/monitor a sector of space for space-borne vehicles 304. This may or may not require a constellation. The intelligent swarm satellite system 400 can utilize one or more machine learning algorithms to facilitate swarming behavior, coordinate activities, generate and implement routing protocols, assign node responsibilities, etc. Implementation of the one or more machine learning algorithms may result in a constellation for the satellites, reconfiguration of a constellation, etc. to effectuate a task. The machine learning algorithms can operate in combination with a trained large language model (LLM) having data for processing and analysis stored on one or more orbiting space vehicles (e.g., space station, medium earth orbit satellites, or any other suitable orbiting space vehicle as desired). The plural satellites 212 are configured to communicate with the one or more space vehicles through the peer-to-peer network (e.g., the LEO internet protocol which is discussed in detail below).

The LLM 112 can be configured to identify space-borne vehicles 304 based on a dataset that includes one or more of image data, positional data, and velocity data detected by the plural satellites 212. For example, the LLM 112 can be configured to receive and process multimodal inputs such as imagery, multilingual plaintext and/or voice, and any other type of data modality as desired. The LLM analyzes the dataset and generates a series of predetermined prompts that support anomaly detection, such as space-borne vehicle detection in a space-based environment. The series of predetermined prompts can initiate the performance of feature analysis, data processing, and space-borne vehicle detection and identification by utilizing calls to outside functions for executing algorithms to process the data. The LLM 112 can be configured as a single LLM that includes short and long-term memory for storing processing results from which the LLM 112 learns. The single LLM is configured to conduct autonomous space-borne vehicle detection tasks by generating a plan for executing the space-borne vehicle detection operation without using or interacting with a secondary and/or external function or model. According to exemplary embodiments, the plural satellites 212 can be configured as autonomous space-borne vehicle detection agents that can leverage any number of anomaly detection algorithms to generate a solution for space-borne vehicle 304 detection without human intervention or interaction. The agent receives the dataset and uses the LLM 112 to reason and identify space-borne vehicles autonomously. In exemplary embodiments, an autonomous anomaly detection agent runs the specified gamut of anomaly detection algorithms in order to arrive at one solution on its own and without human intervention. Once the space-borne vehicle detection has been successfully executed, the LLM 112 can self-reflect on the goal, the plan, and the outcome to try to find any flaws in the logic. If any flaws are discovered, the LLM 112 can revise its plan to mitigate the flaws. After one or more iterations, the LLM agent can generate a cohesive plan that is executed without errors and with successful anomaly detection/identification in a dataset. Further aspects of the space-based LLM described herein are detailed in U.S. patent application Ser. No. 18/937,663 titled Method and System for Autonomous Anomaly Detection Using LM Agents, and U.S. Patent Application No. 63/665,596 titled System and Method for Natural Language Processing at the Edge, the content of each application being hereby incorporated by reference in its entirety.

The processor 110 can instruct the communication module can be configured to selectively communicate with a ground-based node for receiving commands or for updating the LLM 112. The processor can use the ground communication module 140 to send a request to a selected ground node 236 when an update to the LLM 112 is needed, such as when input/output performance of the LLM 112 is degraded, and/or when an embedding update is needed for more efficient and accurate response generation. For example, the processor 112 can be configured to monitor performance of the LLM 112, and when an anomalous response or a response to an input that deviates significantly from what is expected occurs the processor can adjust the parameters of the LLM 112 to temporarily mitigate errors. For example, if the output generated in response a specified parameter of the input is determined to be a hallucination or unintelligible, the processor 110 can determine whether a specific parameter associated with the input should be changed. In another example, the processor 110 can change an input parameter such as input character length of the input, acceptable search terms, etc. If, however, an input/output response results in a score, which on a predetermined scale, indicates a moderate to extreme level of degraded performance, the processor 110 can determine that a file update is needed to address the degraded performance. The processor 112 can measure or score the LLM response at a predetermined and configurable interval and compare the score to a performance metric or threshold.

According to another embodiment, the processor 110 can send a request to a selected ground node 236 when it receives a notification through the ground communication module 140 that an update for the LLM 112 is available. The processor 110 can be configured to update the LLM 112 while the model is still running and/or is operable. The ground communication module 140 can receive a file for updating a portion of the LLM 112. In one example, to update the LLM 112 with the received file, the processor 110 stores a copy of an original file of the LLM 112 in on-board memory 120. The processor 110 next modifies a pointer of the LLM 112 to reference the file copy in on-board memory 120 and downloads the received file to overwrite the original file of the LLM 112. The processor 110 modifies the pointer reference to the original file of the LLM 112 and deletes the file copy from on-board memory 120. According to an exemplary embodiment, the update can be performed in near-real time where no reboot is needed, or delay is encountered for the LLM update to take effect.

According to an exemplary embodiment, the LLM 112 can be configured to implement a no context guardrail. For example, when the LLM 112 receives and processes an input by generating a binary vector which is stored in on-board memory 120. As already discussed, the LLM 112 uses an inverted index that stores a mapping between terms (words or other tokens) and the documents (or other data objects) where those terms appear. The on-board memory 120 can include a list of a list of documents identifiers (e.g., metadata) for each term stored in the inverted index. The document identifiers are also stored in the inverted index 125. If, however, after performing a query no documents can be retrieved from the corpus of instruction manuals and procedural documentation stored in on-board memory 120, the LLM 112 will generate a no context response and terminate the query. As a result, the LLM 112 is prevented from hallucinating and generating a response that is factually incorrect, nonsensical, fabricated, and/or not supported by the corpus of instruction manuals and procedural documentation that provides the knowledge base. Moreover, this implementation also aids in reducing unnecessary power consumption by limiting LLM 112 operations of the processor 110 to periods when information needed to respond to a query or input is present in the corpus. According to an exemplary embodiment, the LLM 112 can be prevented from initiating response generation for a received input if a no context event is determined from pre-processing of the input. For example, if the sensor system 150 detects an event such as a failed launch or aborted flight of a space-borne vehicle 304, the no context guardrail can be implemented at one or more satellites to terminate tracking and identification operations. This implementation is advantageous for deployment in a resource-constrained environment because (1) the processor 110 via the LLM 112 is not consuming resources for information that is not in the corpus of documentation, (2) the operators can have high confidence in the responses generated by the processor 110 via the LLM 112 since no response will be generated without support and/or context in the corpus of documentation, (3) the processor 110 via the LLM 112 will share the results of the no context guardrail events with other agents over the peer-to-peer network 200 and share information with a ground-based node over the transport layer 224 so that no context guardrail implementation can be adjusted and updated across the entire system of satellites 222 (e.g., agents) for maximum energy conservation throughout the system. In another exemplary embodiment, the no-context guardrail can be used to prevent an adversarial attack such as those that attempt to force the LLM 112 to enter an infinite loop of generating inferences. As already discussed, if there is no context for a response to the input provided in the corpus of documentation then the LLM 112 will return a no-context response.

The processor 110 can be part of or in communication with a machine (logic, one or more components, circuits (e.g., modules), or mechanisms). The processor 114 can be hardware (e.g., processor, integrated circuit, central processing unit, microprocessor, core processor, computer device, etc.), firmware, software, or any combination thereof configured to perform operations by execution of instructions embodied in algorithms, data processing program logic, artificial intelligence programming, automated reasoning programming, and so forth. Use of a processor 110 herein can include any one or combination of a Graphics Processing Unit (GPU), a Field Programmable Gate Array (FPGA), a Central Processing Unit (CPU), and so forth. The processor 114 can include one or more operating modules. An operating module can be a software or firmware operating module configured to implement any of the method steps disclosed herein. The operating module can be embodied as software and stored in memory 120, the memory 120 being operatively associated with the processor 10. An operating module can be embodied as a web application, a desktop application, a console application, and so forth.

The processor 110 can include or be associated with a computer or machine-readable medium. The computer or machine-readable medium can include memory. The computer or machine-readable medium can be configured to store one or more instructions thereon. The instructions can be in the form of algorithms, program logic, a model, or any combination therefore that cause the processor 110 to perform any of the functions described herein.

The processor 110 can be in communication with other processors of other devices (e.g., a computer device, a desktop computer, a laptop computer, a computer system, etc.). Any of those other devices can include any of the exemplary processors 110 disclosed herein. Any of the processors 110 can have transceivers or other communication devices/circuitry to facilitate transmission and reception of wireless signals. Any of the processors 110 can include an Application Programming Interface (API) as a software intermediary that allows two applications to talk to each other. Use of an API can allow software of the processor 110 of the system to communicate with software of the processor of the other device(s), if the processor 110 of the system is not the same processor 110 of the device.

Any data transmission between the processor 110 and a memory 120, between the processor 110 and a database, between the processor 110 and processors of other devices, between the processor 110 of one operating module and a processor of another operating module, etc. can be via a pull operation (e.g., the processor 110 can pull the data) or a push operation (e.g., the data can be pushed to the processor 110). The processor 110 can receive and process the data in steaming format, store it in memory before being processed, etc.

The processor 110 can be configured to be a component of, used in combination with, or in communication with another device/system-e.g., this can include the processor 110 being part of the device/system, the device/system being part of the processor 110, the processor 110 in communication with the device/system, etc. “Being part of” can include being on a same substrate or integrated circuit.

The processor 110 can be a component of, used in combination with, or in communication with a predictive modeling system, a decision support system, an automated control system, etc. The processor 110 can use the techniques disclosed herein to assist with or augment the performance of these devices/systems.

According to an exemplary embodiment, the ability to form and modify routing protocols, assign and re-assign node responsibilities, configure and reconfigure constellations, etc. can allow the peer-to-peer network 200 to achieve self-healing. Each satellite 212 can be configured to monitor one or more other satellites 212 in the network by, for example, sending out periodic requests to gather performance metrics (e.g., computational/processing usage, memory utilization, network traffic, etc.). Analysis of the monitoring data can be performed by the processor(s) of the satellite 102 to identify potential issues with the other satellites 212 to which the request(s) had been sent. This monitoring operation can be performed continually, periodically, in accordance with a predetermined scheme, as dictated by a machine learning algorithm, etc. Based on the assessed health of the satellites 212, the peer-to-peer network can self-heal by adjusting routing protocols, re-assign node responsibilities, and/or reconfigure constellations to reroute data around failed satellites 212 to compensate. This can be done automatically by the satellites 212 in the network.

According to an exemplary embodiment, the processor 110 can be configured by the LLM 112 to monitor peer-to-peer communication on the space-based mesh network 200. The space-based mesh network 200 can have plural communication protocols available for communication. For example, the communication protocols can include user datagram protocol (UDS), transmission control protocol (TCP), or any other suitable communication protocol as desired. The LLM 112 can cause the processor 110 to monitor communication by the satellites 212 connected to the mesh network 200. In a space-based implementation, each satellite 212 can be configured to monitor the other satellites connected to the space-based mesh network 200 and the communication traffic on the space-based mesh network 200. The processor 110 can perform packet capture and intrusion detection operations. According to an exemplary embodiment, the processor 110 can download the captured packets to a ground-based node 232, 234, 236 to perform advanced processing on the data. The ground-based node 232, 234, 236 can be configured with greater processing capacity to execute tools and/or a software package designed for measuring network performance. The ground-based node 232, 234, 236 can upload results of the network data processing to the satellite 100 via the spaced-based transport layer 224. If the processing result identifies degraded performance, the processor 110 can be configured to change the communication protocol when an exploit, such as an intrusion to the mesh network 200 by an unauthorized and/or unknown device, on the mesh network 200 is detected. For example, one of the satellites 212 in the space-based mesh network 200 can send a message to the other satellites that identifies the new communication protocol on which peer-to-peer communication is to be conducted.

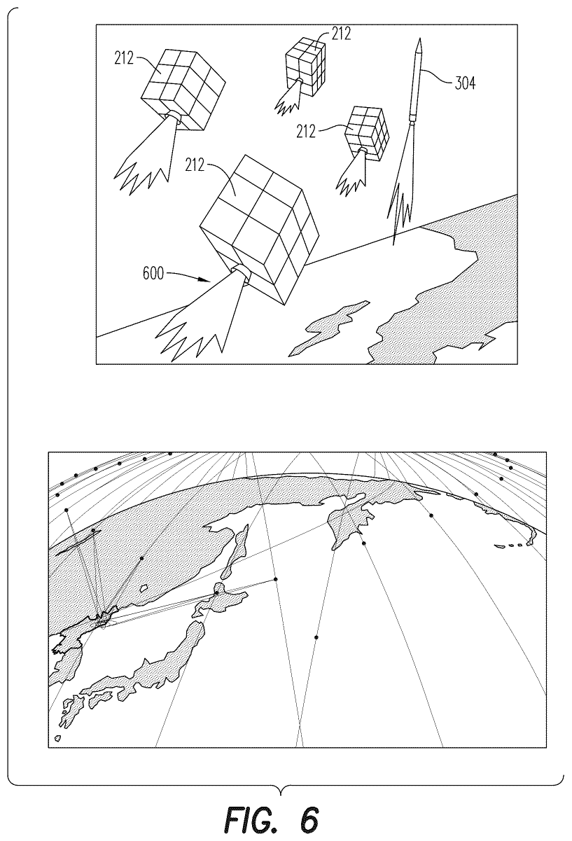

An exemplary implementation of the intelligent swarm system of FIGS. 3 and 4, can be providing a missile defense system for the United States. In this exemplary implementation, it is contemplated for the constellation to include 1,000 satellites 212 distributed across twenty orbital planes. The satellites 212 can be held in sun-synchronous orbits using the Position, Navigation, and Timing (PNT) navigational system of the satellite. Each orbital plane can host fifty satellites 212 organized into ten squadrons 220—e.g., each squadron can have five satellites 212. FIG. 6 illustrates a satellite with propulsion system according to an exemplary embodiment. As shown in FIG. 6, one or more of the satellites 212 can engage a space-borne vehicle 304 by propelling into the space-borne vehicle 304 and/or the missile's 304 trajectory. With this exemplary constellation, the satellites 212 would be operating within 300-600 km orbits. The satellites 212 would require sufficient delta-v for missile interception. The velocity required for missile interception can be provided by a propulsion system 600. For example, the propulsion system 600 utilized by the satellites 212 can propel the satellite 212 into the space-borne vehicle 304 and/or the space-borne vehicle's 304 trajectory at a sufficient a delta-v to achieve interception. According to an exemplary embodiment, the propulsion system 600 can provide a delta-v within a range from 1 to 4 km/s.

Each of the plural satellites 212 can be configured to participate in an organization of the plural satellites 212 to form a squadron (e.g., swarm) 210 of satellites 212 representing the synthetic array aperture 500 based on the shared data. For instance, each satellite 212 can serve as a detection point (e.g., antenna) that receives information about the space-borne vehicle 304. Using RADAR for example, each satellite's sensory system 150 can generate successive pulses of radio waves which are transmitted to illuminate a sector. Should a missile enter the sector, echo(s) of the pulse(s) from the space-borne vehicle 304 is/are received and recorded. The sensor system 150 (e.g., antenna) aperture of the satellite 100 is the area spanned (e.g., the scanned sector) by the satellite 100. As the satellite 100 moves (e.g., it is in orbit about the Earth), the sensory system's 150 location relative to the space-borne vehicle 304 changes with time. Signal processing of successive recorded echoes can combine the recordings from the multiple sensor system 150 positions to form a synthetic detector (or antenna) aperture that is larger and provides higher resolution than the detector (or antenna) aperture 500. The above example was discussed using RADAR, but it is understood that LIDAR or other techniques can be used.

Which satellites 212 are used to form squadron 210, when to form a squadron 210, how many squadrons 210 to form, how large of an area to be scanned by the squadron 210 or how large of a synthetic array aperture 500 to generate, etc. can be determined by one or more of the machine learning algorithms, which can, for example, utilize an objective or cost function for such determination. For instance, a cost function can optimize use of computational resources, operational functionality, energy usage, operational continuity, etc. to determine arrangement and configurations of squadron(s) 220 and constellation(s) for the/those squadron(s) 220, which can then be translated into node responsibility assignments and routing protocols. For example, the machine learning algorithms can receive data from among the one or more satellites regarding satellite positions and/or space-borne vehicle positions to assess which satellites are best suited and organized to form the synthetic array aperture 500.

The squadrons 210 can be formed before any space-borne vehicle(s) 304 are detected, formed after the space-borne vehicle(s) 304 is/are detected, dynamically adjusted based on conditions, dynamically adjusted to provide most optimal tracking of the space-borne vehicle(s) 304, dynamically adjusted to address needs associated with computational resources, operational functionality, energy usage, operational continuity, etc.

Each of the plural satellites 212 can be configured to intercept and space-borne vehicle 304 within the synthetic array aperture 500. For instance, once a space-borne vehicle 304 is detected and a squadron 210 forming a synthetic array aperture 500 is generated to track the space-borne vehicle 304, the satellites 212 within that squadron 210 can respond to the space-borne vehicle 304. The response can be to adjust constellation to continue to track the space-borne vehicle 304, communicate to satellites 212 outside of the squadron 210 to further assess the threat (e.g., provide situational awareness to the intelligent swarm satellite system 100 to allow the machine learning algorithm to determine if/when/how to respond to the threat), engage the space-borne vehicle 304 to deflect it, render it inoperable, destroy it, etc.

The intelligent swarm satellite system can share data between the plural satellites 212. This data can be obtained via the sensor system 150 on each of the plural satellites 212. The sensor system 150 can generate signals representative of the detections/measurements made, and these signals can be communicated to one or more of the other satellites 212 via the peer-to-peer network. The machine learning algorithm can apply the shared data to fusion techniques, predictive analytics, multi-variant analyses, etc. to determine node responsibility assignments and routing protocols. In addition, while the intelligent swarm satellite system is not dependent upon ground/terrestrially-based systems 232, 234, 236, ground/terrestrially-based systems 232, 234, 236 can provide additional data for sharing among the plural satellites 212. The one or more machine learning algorithms can determine if/when/how/to-which-degree to limit data sharing and data analytics to a single satellite 100, to a squadron 210, to plural squadrons 210, satellites 212 etc.

The one or more machine learning algorithms can provide collective sensorial awareness. With the data sharing via the peer-to-peer network, each satellite's 212 processor 110 can monitor and track each other satellite's 212 agentic capabilities and taskable sensor system 150. The intelligent swarm satellite system 400 can include an assessment module that assesses each satellite's 212 capabilities and sensor system 150 functions to assess current and/or predicted need for computational resources, operational functionality, energy usage, operational continuity, etc. This assessment can be used to determine node responsibility assignments and routing protocols to optimize a function of the system, ensure that an operation is executed, and so forth. This is another aspect that can facilitate the plural satellites 212 behaving as a swarm.

Referring to FIGS. 4 and 5, at least one satellite 212 can be configured to engage the space-borne vehicle 304. For instance, after the space-borne vehicle 304 is detected and is being tracked by the squadron (e.g., swarm) 210, one or more of the satellites 212 in the squadron 210 (or outside of the squadron 210 should the machine learning algorithm dictate), can be directed to (e.g., via node responsibility assignment) to engage the space-borne vehicle 304. Engaging the space-borne vehicle 304 can involve attacking the space-borne vehicle 304, deflecting the space-borne vehicle 304, rendering the space-borne vehicle 304 inoperable, destroying the space-borne vehicle 304, or any other actions known in the art for engaging and disabling, altering, or destroying a space-borne vehicle. For instance, the satellite 100 can include a weapon system (e.g., laser weapon, kinetic weapon, EM pulse weapon, etc.) to engage the space-borne vehicle 304. The machine learning algorithm can generate a node responsibility assignment for one or more of the satellites 212 to actuate the weapon system. While the satellite(s) 212 can include weapon systems, the satellite(s) 212 themselves can be weapons. For instance, the satellite(s) 212 can include propulsion systems (e.g., thrusters, rocket boosters, etc.), target acquisition systems, altitude and orbit control systems, etc. to facilitate the satellite(s) 212 projecting itself into the trajectory of the space-borne vehicle 304 and impacting the space-borne vehicle 304.

The determination of which satellite 212 will engage the space-borne vehicle 304 can be a determined by an objective or cost function that weighs the need for that satellite's 212 computational/processing resources, the need for that satellite 212 to maintain a peer-to-peer network topology, etc. In other words, the information obtained from the plural satellites 212 can be used by the one or more machine learning algorithms to generate a situational awareness, and a voting scheme can be used to determine which satellite 212 can effectively engage the space-borne vehicle 304 with minimal operational degradation to the intelligent swarm satellite system 100—e.g., a voting scheme in the networked system can be implemented, for example, by using an objective or cost function that weighs the need for that satellite's 212 computational/processing resources, the need for that satellite 212 to maintain a peer-to-peer network topology, etc. The voting scheme can be implemented via scoring scheme that assigns a score to the satellites 212 based on situational awareness, current and predicted network topology, current and predicted computational and energy resources, effectiveness and probability of engaging the space-borne vehicle 304 in LEO, etc. The satellite 212 selected by the machine learning algorithm to be the one to engage the space-borne vehicle 304 can be based on the scoring scheme.

While the satellites 212 can utilize any of the sensor system 150 disclosed herein, it is contemplated for the sensor system 150 to use electro-optic detection techniques (e.g., photosensors to receive optical or electromagnetic signals and convert them to electrical signals) to detect the space-borne vehicle 304. Thus, the satellite(s) 212 can be configured to detect the missile using an electro-optic detection technique. It is further contemplated for the satellite(s) 212 to identify and/or classify the space-borne vehicle 304 using a machine learning algorithm. Thus, one or more machine learning algorithms of the intelligent swarm satellite system can include an object identification and classification model trained on a trained data set of missiles (e.g., missile imagery, missile trajectory, etc.).

The intelligent swarm satellite system can include one or more machine learning algorithms to determine whether the missile is in a boost/ascent missile phase, a mid-course missile phase, or a terminal missile phase. This determination can allow the intelligent swarm satellite system 400 to appropriately assign node responsibility assignments by feeding information of which phase the space-borne vehicle 304 is in to an objective or cost function, for example, for optimizing computational resources, operational functionality, energy usage, operational continuity, etc.

As can be appreciated from the present disclosure, embodiments can also relate to a method for intercepting a space-borne vehicle 304. The method can involve deploying plural satellites 212 configured with swarm intelligence. Each satellite 212 can have plural sensor system 150 (e.g., sensors) and on-board machine learning algorithms. The method can involve measuring data with the plural sensors of each satellite 212. The method can involve communicating, via peer-to-peer communication, data from each satellite 212 among the plural satellites 212 to enable the swarm intelligence. The peer-to-peer communication can be facilitated by a space-based mesh network. The method can involve forming a synthetic array aperture 500 with the plural satellites 212 using the swarm intelligence. The method can involve detecting a and tracking a space-borne vehicle 304 within the synthetic array aperture 500 to intercept a space-borne vehicle 304 in coordination with other satellites 212 in the synthetic array aperture 500.

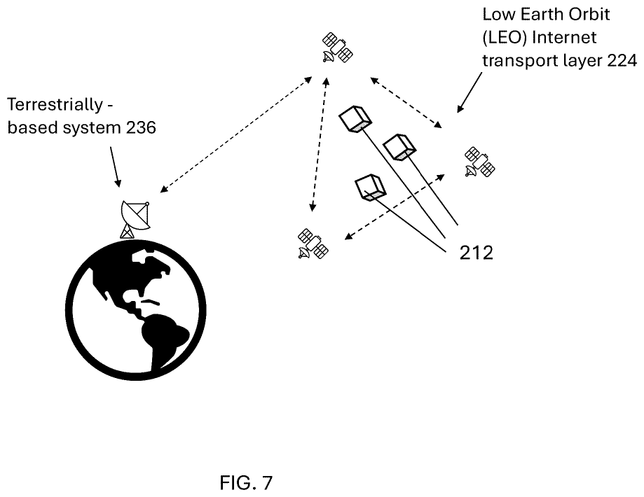

As shown in FIG. 7, the method can involve measuring new data with the plural sensors of at least one satellite 212. The method can involve updating the data among the plural satellites 212 in real time via the peer-to-peer communications based on the at least one satellite 212 sharing the new data among the plural satellites 212. At least one satellite 212 of the plural satellites 212 can have a unique internet protocol (IP) address, which can allow it to be a node in the LEO internet transport layer 224. This can be achieved via a Dynamic Host Configuration Protocol (DHCP) of the LEO internet transport layer 224, in which a satellite of the LEO internet transport layer 300 (serving as the router) network allocates available IP addresses to the satellites 212 when the satellites 212 connect with (e.g., establish a network handshake) the LEO internet transport layer 300 network.

The method can involve establishing a LEO internet transport layer 224 or connecting with a LEO internet transport layer 224 by which each satellite 212 is in communication with each other satellite 212. The method can involve causing at least one satellite 100 to be in communication with a terrestrially-based system 232, 234, 236 via the LEO internet transport layer 224.

The method can involve detecting a space-borne vehicle(s) 304 using an electro-optic detection technique(s) and identifying and/or classifying the space-borne vehicle(s) 104 using a machine learning algorithm(s).

The method can involve engaging a space-borne vehicle(s) 304 with at least one satellite 212.

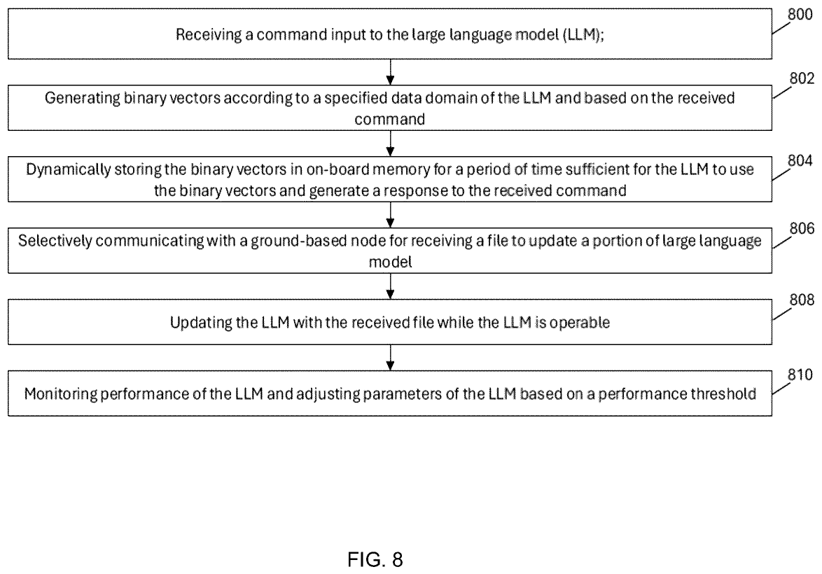

FIG. 8 illustrates method for using large language model control in space with managed power consumption according to an exemplary embodiment. The Step 800 involves the satellite 100 receiving a command input to the large language model (LLM) 112. The command can be received from a ground-based node 232, 234, 236 or an authorized (i.e., friendly) space-based vehicle over the space-based network 200 via the space-based transport layer 224. Step 802 involves the processor 110 generating binary vectors according to a specified data domain of the LLM 112 and based on the received command. The specified data domain includes a corpus of documentation on which the LLM will use to generate the response to the command. Step 804 involves the processor dynamically storing the binary vectors in on-board memory for a period of time sufficient for the LLM 112 to use the binary vectors and generate a response to the received command. The processor 110 selectively communicates with a ground-based node 236 for receiving a file to update a portion of large language model (Step 806). In step 808, the processor 110 updates the LLM 110 with the received file while the LLM 112 is operable, and monitors performance of the LLM 112 and adjusting parameters of the LLM 112 based on a performance threshold (Step 810).

It should be understood that the disclosure of a range of values is a disclosure of every numerical value within that range, including the end points. It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be apparent to those skilled in the art that numerous modifications and variations of the described examples and embodiments are possible considering the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof.

It should be understood that modifications to the embodiments disclosed herein can be made to meet a particular set of design criteria. Therefore, while certain exemplary embodiments of the systems and methods using and making the same disclosed herein have been discussed and illustrated, it is to be distinctly understood that the invention is not limited thereto but may be otherwise variously embodied and practiced within the scope of the following claims.

What is claimed is:

1. A satellite configured for operation in space using a large language model control with managed power consumption, the satellite comprising:
a processor configured by the large language model to receive a command and generate binary vectors according to a specified data domain of the LLM and based on the received command;
on-board memory dynamically storing the binary vectors for a period of time sufficient for the LLM to use the binary vectors and generate a response to the received command; and
a communication module configured to selectively communicate with a ground-based node for receiving a file for updating a portion of large language model;
the processor being configured to update the large language model with the received file while the large language model is operable; and
the processor being configured to monitor performance of the LLM and adjust parameters of the LLM based on a performance threshold.

2. The satellite of claim 1, wherein the processor is configured to update the large language model with an update file received from a ground-based node when degraded performance is detected.

3. The satellite of claim 1, wherein to update the large language model with a received file, the processor is configured to:
store a copy of an original file of the LLM in on-board memory;
modify a pointer of the LLM to reference the file copy in on-board memory;
download the received file to overwrite the original file of the LLM;
modify the pointer of the LLM to reference the original file of the LLM; and
delete the file copy from on-board memory.

4. The system of claim 1, wherein:
the processor being configured by the LLM to monitor traffic on a communication network, and
the processor being configured to change the communication protocol when an exploit on the communication network is detected.

5. The system of claim 1, wherein the performance threshold measures a degradation in input performance of the LLM, output performance of the LLM, hardware detecting potential performance degradation of the LLM due to cosmic radiation, or any combination thereof.

6. The system of claim 1, wherein the processor is configured to retrieve the binary vectors from random access memory (RAM) of the Satellite or a file on a hard drive of the Satellite, without using a vector database.

7. The system of claim 6, wherein the processor is configured to:
receive a request, from an operator or another device;
converting at least part of the request to a vector that represents the semantic meaning of the request;
using the vector that represents the semantic meaning of the request to compare with one or more of the binary vectors stored in the RAM;
selecting data associated with the request based on a similarity measurement between the request and the binary vectors;
providing the LLM with information based at least in part on the selected data.

8. The system of claim 7, wherein the similarity measurement comprises at least one of a cosine similarity measurement and Euclidean distance measurement.

9. The system of claim 7, wherein the processor is configured to traverse binary vectors in a sequence according to length of the binary vector t and to select selecting the binary vector with the greatest similarity to the request vector using at least one of a cosine similarity measurement and Euclidean distance measurement.

10. The system of claim 6, wherein each of the binary vectors comprise a set of 1s and 0s to approximately represent semantic meaning of a document;
wherein the processor is configured to retrieve the document from the on-board memory to use as context for the LLM, the document corresponding to the binary vector.

11. The system of claim 1, wherein:
the memory is configured to store a corpus of documentation for generating the response to the received command; and
the processor is configured to generate a no-context response when information cannot be retrieved from the corpus in response to the received command.

12. A method for using large language model control in space with managed power consumption, the method comprising:
receiving a command input to the large language model (LLM);
generating binary vectors according to a specified data domain of the LLM and based on the received command;
dynamically storing the binary vectors in on-board memory for a period of time sufficient for the LLM to use the binary vectors and generate a response to the received command;
selectively communicating with a ground-based node for receiving a file to update a portion of large language model;
updating the LLM with the received file while the LLM is operable; and
monitoring performance of the LLM and adjusting parameters of the LLM based on a performance threshold.

13. The method of claim 12, further comprising:
updating the large language model with an update file received from a ground-based node when degraded performance is detected.

14. The method of claim 12, wherein updating the LLM comprises:
storing a copy of an original file of the LLM in on-board memory;
modifying a pointer of the LLM to reference the file copy in on-board memory;
downloading the received file to overwrite the original file of the LLM;
modifying the pointer of the LLM to reference the original file of the LLM; and
deleting the file copy from on-board memory.

15. The method of claim 12, comprising:
monitoring traffic on a communication network; and
changing the communication protocol when an exploit on the communication network is detected.

16. The method of claim 12, comprising:
retrieving the binary vectors from random access memory (RAM) of the Satellite or a file on a hard drive of the Satellite, without using a vector database.

17. The method of claim 16, comprising:
receiving a request, from an operator or another device;
converting at least part of the request to a vector that represents the semantic meaning of the request;
using the vector that represents the semantic meaning of the request to compare with one or more of the binary vectors stored in the RAM;
selecting data associated with the request based on a similarity measurement between the request and the binary vectors; and
providing the LLM with information based at least in part on the selected data.

18. The method of claim 17, comprising:
performing the similarity measurement between the request vector and the binary vectors using at least one of a cosine similarity measurement and Euclidean distance measurement.

19. The method of claim 17, comprising:
traversing the binary vectors in a sequence according to length; and
selecting the binary vector with the greatest similarity to the request vector using at least one of a cosine similarity measurement and Euclidean distance measurement.

20. The method of claim 19, wherein each of the binary vectors comprise a set of 1s and 0s to approximately represent semantic meaning of a document, the method comprising:
retrieving the document from the on-board memory to use as context for the LLM, the document corresponding to the selected binary vector.

21. The method of claim 12, comprising:
storing a corpus of documentation for generating the response to the received command in the on-board memory; and
generating a no-context response when information cannot be retrieved from the corpus in response to the received command.
